(19) United States
(12) Patent Application Publication
(10) Pub. No.: US 2008/0182066 A1
(43) Pub. Date: Jul. 31, 2008

(54) Apparatus and Process for Producing Metallic Honeycomb Bodies with at Least One Shaping Segment, Honeycomb Structure Produced by the Apparatus or the Process and Vehicle Having the Honeycomb Structure

(75) Inventors: Michael Voit, Leverkusen (DE); Frank Frechen, Lohmar (DE)

Correspondence Address: LERNER GREENBERG STEMER LLP, P O BOX 2480, HOLLYWOOD, FL, 33022-2480, US

(73) Assignee: EMITEC GESELLSCHAFT FUR EMISSIONSTECHNOLOGIE MBH, Lohmar (DE)

(21) Appl. No.: 12/029,954

(22) Filed: Feb. 12, 2008

Related U.S. Application Data
(63) Continuation of application No. PCT/EP2006/007970, filed on Aug. 11, 2006.

(30) Foreign Application Priority Data
Aug. 12, 2005 (DE) 10 2005 038 572.9

(51) Int. Cl. B32B 3/12; B65H 75/18

(52) U.S. Cl. 428/116; 242/610.5

(57) ABSTRACT

An apparatus for winding at least partially structured metal foils into a honeycomb structure includes at least one wrap-around mandrel in a central region of the apparatus having a receiving part for at least one metal foil, at least one shaping segment having at least one guide element for guiding the at least one metal foil during winding, and at least one pivotable clamping jaw. The at least one guide element has at least one roll body. A process for producing a honeycomb body, especially a large honeycomb body, with at least partially structured metal foils, a honeycomb structure produced by the apparatus or the process and a vehicle having the honeycomb structure, are also provided.

### CROSS-REFERENCE TO RELATED APPLICATION

This is a continuing application, under 35 U.S.C. § 120, of copending International Application No. PCT/EP2006/007970, filed Aug. 11, 2006, which designated the United States; this application also claims the priority, under 35 U.S.C. § 119, of German Patent Application DE 10 2005 038 572.9, filed Aug. 12, 2005; the prior applications are herewith incorporated by reference in their entirety.

### BACKGROUND OF THE INVENTION

### Field of the Invention

The invention relates to an apparatus for winding at least partially structured metal foils to form a honeycomb structure and to a process for producing a honeycomb body with at least partially structured metal foils. The invention also proposes particularly preferred configurations of a honeycomb structure and a honeycomb body, as well as their use in the automotive sector.

The invention relates in particular to honeycomb bodies which can be integrated in an exhaust system, where they help to respectively eliminate and convert pollutants contained in the exhaust gas. For example, it is known to use honeycomb bodies as carrier bodies for various coatings in order to bring about corresponding chemical reactions with the exhaust gas, for example as catalytic converters, adsorbers, etc. Furthermore, honeycomb structures of that type can also be used to form an open or closed particulate filter, which may in turn be coated if appropriate. Finally, it is also known for metallic honeycomb bodies of that type to be supplied with current at least at times, so as to function as a heating element, or to provide the metallic honeycomb body with microstructures, so that it then acts as a flow mixer.

In theory, a distinction is drawn in particular between two typical forms of metallic honeycomb bodies. One form, of which German Published, Non-Prosecuted Patent Application DE 29 02 779 A1, corresponding to U.S. Pat. No. 4,273,681 shows typical examples, is the spiral form, in which substantially one smooth and one corrugated metal foil are placed on top of one another and wound up in a spiral shape. In another form, the honeycomb body is constructed from a large number of alternately disposed smooth and corrugated or differently corrugated metal foils, in which case the metal foils first of all form one or more stacks, which are then intertwined. In that case, the ends of all of the metal foils come to lie on the outside and can be joined to a housing or tubular casing, resulting in the formation of numerous joints, increasing the durability of the honeycomb body. Typical examples of those forms are described in European Patent EP 0 245 737 B1, corresponding to U.S. Pat. Nos. 4,832,998, 4,803,189, 4,946,822 and 4,923,109 or International Publication No. WO 90/03220, corresponding to U.S. Pat. Nos. 5,105,539 and 5,139,844.

It has long also been known to provide the metal foils with additional structures in order to influence the flow and/or to effect mixing between the individual flow passages. Typical examples of configurations of that type include International Publication No. WO 91/01178, corresponding to U.S. Pat. No. 5,403,559; International Publication No. WO 91/01807, corresponding to U.S. Pat. Nos. 5,130,208 and 5,045,403; and International Publication No. WO 90/08249, corresponding to U.S. Pat. No. 5,157,010. Finally, there are also honeycomb bodies in conical form which may, if appropriate, also be constructed with further additional structures for influencing flow, see for example International Publication No. WO 97/49905, corresponding to U.S. Pat. No. 6,190,784. Furthermore, it is also possible to provide honeycomb bodies with a cutout for a sensor, as described in German Utility Model DE 88 16 154 U1.

The winding operation, i.e. the operation in which the honeycomb body is shaped from a sheet-like stack into a cylindrical or conical body, presents technical problems in the production of the honeycomb body, since it is preferable to use very thin metal foils. The thin metal foils have the advantage of allowing a high number of passages per unit volume of the honeycomb body while at the same time the surface-specific heat capacity of the honeycomb body is reduced, so that the latter follows the fluctuating thermal stresses in the exhaust system more quickly. However, there is also a respective risk, for example, of the corrugated metal foils becoming deformed during winding and of different passage shapes being formed during winding. This has an adverse effect on the subsequent flow behavior of the exhaust gas in the exhaust system.

A method for producing metallic honeycomb bodies which already functions very successfully is disclosed by International Publication No. WO 97/00135, corresponding to U.S. Pat. Nos. 6,049,961 and 6,505,396. Those documents propose an apparatus for producing a honeycomb body from at least one stack made up of a multiplicity of at least partially structured metal sheets, wherein at least two shaping segments are provided. Each shaping segment can in each case be pivoted in the opposite direction to the direction of rotation of the wrap-around device, about a pivot axis in each case running parallel to the axis of the wrap-around device. Pivoting each shaping segment in the direction opposite to the direction of rotation of the wrap-around device prevents the sheet-metal stacks from being compressed together when the die is closed. It was recognized in the above-mentioned documents that it is more favorable for the shaping segment which functions as an abutment to bear directly against the stacks. The portion of each stack that has not yet been wrapped around is free. The result is that no significant stresses are formed in the section of the stack which has not yet been wrapped around, with the result that bending stresses are avoided therein.

The honeycomb bodies can be used both in mobile exhaust systems of internal combustion engines (e.g. spark-ignition engines, diesel engines and the like) and in stationary operation. In that context, in particular honeycomb bodies with a relatively large diameter are also used, which presents particular technical difficulties in production. For example, it must be taken into account that for a cylindrical metallic honeycomb body in the form of a spiral with a diameter of more than 150 mm it is necessary to use metal foils with a length of over 10,000 mm and a weight of approximately 1,500 g or more.

Relatively thick and long stacks also have to be joined together in the structural forms including the stacks of metal foils. On one hand, that makes handling of the metal foils and in particular the winding operation difficult. On the other hand, during the winding operation, the force-introduction points are usually further away from the central region of the winding apparatus, making it difficult to ensure a uniform introduction of force over the entire cross section and therefore also a uniform structure of the honeycomb body in a reliable series-production process. Furthermore, during winding a large number of friction locations are produced, with the result that during that process high forces need to be applied when using large honeycomb structures, resulting, however, in an increased risk of deformation of the metal foils.

### SUMMARY OF THE INVENTION

It is accordingly an object of the invention to provide an apparatus and a process for producing metallic honeycomb bodies with at least one shaping segment, a honeycomb structure produced by the apparatus or the process and a vehicle having the honeycomb structure, which overcome the hereinafore-mentioned disadvantages of the heretofore-known apparatuses and a processes of this general type and at least partially solve the technical problems outlined in connection with the prior art. In particular, it is intended to provide an apparatus for winding at least partially structured metal foils to form a honeycomb structure which, in a reliable process, allows the manufacture of even large honeycomb bodies and at the same time reduces the risk of deformation to the metal foil during winding. Furthermore, it is intended to provide a process for producing a honeycomb body, as well as respective honeycomb structures and honeycomb bodies, that are suitable for use in mobile exhaust systems.

With the foregoing and other objects in view there is provided, in accordance with the invention, an apparatus for winding at least partially structured metal foils to form a honeycomb structure. The apparatus comprises a central region of the apparatus, at least one wrap-around or winding mandrel disposed in the central region and having a receiving part or receptacle for at least one metal foil, and at least one shaping segment having at least one guide element for guiding the at least one metal foil during winding and at least one pivotable clamping jaw. The at least one guide element has at least one roll body.

First of all, it should be noted that the term “winding” is to be understood as meaning not just winding up the metal foils in a spiral but also bending over, twisting together and intertwining metal foils, so that they are deformed, for example, in the shape of an S, W, M, V and the like. In principle it is possible for a metal foil to be partially structured and partially smooth, although it is preferable for completely smooth and completely structured metal foils to be wound together to form a honeycomb structure.

The apparatus includes at least one wrap-around or winding mandrel. It is preferable to provide precisely one wrap-around mandrel if spiral-shaped winding is to be carried out to construct the honeycomb structure. The metal foils in this case are releasably connected to the wrap-around mandrel, which during production itself executes a rotary movement and thereby winds up the metal foils. If a plurality of stacks of metal foils are wound together simultaneously, it is preferable to provide the same number of wrap-around mandrels as there are stacks of metal foils. They should advantageously be positioned at the same distance and same spacing with respect to a center point of the apparatus. A receiving part for at least one metal foil may, for example, be formed with the wrap-around mandrel, in such a manner that measures are provided to substantially prevent a relative movement of the at least one metal foil with respect to the wrap-around mandrel.

Furthermore, at least one shaping segment is provided. The shaping segment forms a type of abutment which externally assists the construction of the honeycomb structure during the winding. For this purpose, the shaping segment has at least one guide element, through the use of which the metal foils are guided into the central region. The metal foils in particular slide past the guide element into the central region. The shaping segment also has a pivotable clamping jaw, which is in particular configured in such a way that it can be pivoted toward the central region. The clamping jaw serves in particular to actively move partial regions, in particular end regions, of the metal foils toward the central region of the apparatus. In this context, in a preferred configuration, the clamping jaws, in their pivoted-out position, completely surround the central region of the apparatus, so that they then simulate the external contour of the honeycomb structure. It is preferable to provide at least 3 shaping segments, and in particular in the case of relatively large honeycomb structures the apparatus has, for example, 3, 4 or 5 shaping segments.

With regard to the at least one guide element of the shaping segment, it is now also proposed that at least one roll body be provided. As has already been stated above, the at least one metal foil slides along the guide element when the wrap-around mandrel is set in rotation. As a result, during the winding process friction is formed upon the contact of the metal foil with the guide element. The provision of a roll body in this region now leads to a reduction in the friction, since the roll body rests against the metal foil and rolls along the surface as the metal foil is guided past it. In principle, it is possible to provide a plurality of roll bodies on one guide element and for these roll bodies to be in contact with the at least one metal foil during the winding process, but it is preferable to provide just a single roll body per guide element. The reduced friction at this location has a significant influence on the forces that can be applied by the wrap-around mandrel during the winding process, specifically reducing those forces. Moreover, the service life of the shaping segment is increased. Finally, a further factor is reduced abrasion of the metal foils, thereby simplifying maintenance of an apparatus of this type. All of these aspects, in particular for large honeycomb structures, lead to an even more uniform structure, with the result that in subsequent use in an exhaust system it is possible to achieve a controlled flow behavior of the exhaust gases as they pass through the honeycomb body.

In accordance with another feature of the apparatus of the invention, the at least one shaping segment is movable relative to the at least one wrap-around mandrel. This is to be understood in particular as meaning that the shaping segment as a whole can be translationally displaced with respect to the central region of the apparatus. This translational movement, in particular if round honeycomb structures are to be produced, is preferably directed radially outward from the central region of the apparatus. Thus, the shaping segment, for example as the honeycomb body is built up in an increasing diameter, can be moved outward, away from the central region of the apparatus, so that at any time during winding it is ensured that the shaping segment is in contact with the at least one metal foil by way of the guide element. For an explanation of the basic function or basic structure of an apparatus of this type with relatively movable shaping segments, reference is made to the content of International Publication No. WO 97/00135, corresponding to U.S. Pat. Nos. 6,049,961 and 6,505,396, which is hereby incorporated by reference in its entirety into the subject matter of the instant application.

In accordance with a further advantageous feature of the apparatus of the invention, at least one shaping segment is constructed with one guide element and one clamping jaw, with the guide element and the clamping jaw being disposed adjacent one another. The provision of just one single guide element on one hand ensures successful guidance of the at least one metal foil but on the other hand also ensures the presence of only low frictional forces. The guide element and the clamping jaw are preferably produced as a single part in this case, in which case the guide element is, for example, a protruding region of the clamping jaw. In this context, it should be taken into account that the at least one roll body is therefore also positioned in the immediate vicinity of the clamping jaw or adjoins the clamping jaw.

In accordance with an added feature of the apparatus of the invention, the at least one clamping jaw of the at least one shaping segment has a pivot axis which coincides with an axis of rotation of the at least one roll body. A configuration of the roll body of this type ensures that the roll body is in contact with the metal foils even in the pivoted-out position of the clamping jaw, and the clamping jaw moves the adjoining part of the metal foil toward the central region.

In accordance with an additional feature of a preferred variant embodiment of the apparatus of the invention, at least one guide element of the at least one shaping segment forms a contact surface for the at least one metal foil, with at least 50% of the contact surface being formed by the at least one roll body. In a preferred configuration in this case, at least 80% of the contact surface or even the entire contact surface is formed by the at least one roll body.

In a configuration where at least 50% of the contact surface is formed by a roll body, it is already possible to significantly reduce the friction as the at least one metal foil is guided past the guide element. In order to ensure a prestress, it may be advantageous to permit a certain degree of friction. In particular, in the case of large honeycomb bodies or honeycomb structures, a higher proportion of the contact surface is formed by the at least one roll body, so that the criterion of reducing friction is kept at the forefront.

In accordance with yet another advantageous feature of the apparatus of the invention, at least one guide element of the at least one shaping segment is configured in such a way that the at least one roll body is formed so as to protrude toward the central region of the apparatus. This is to be understood in particular as meaning that the guide element and the clamping jaw are produced from one part with an outer surface which is such that they merge into one another, with the separate roll body protruding slightly beyond the part or its outer surface. This ensures that the metal foils in fact bear only against the roll body.

With the objects of the invention in view, there is also provided a process for producing a honeycomb body with at least partially structured metal foils. The process comprises:
a) providing at least one smooth metal foil and at least one structured metal foil;
b) winding the metal foils to form a honeycomb structure using an apparatus according to the invention described above;
c) introducing the honeycomb structure into a housing; and
d) joining the metal foils to the housing.

Accordingly, in step a) it is preferable to provide a plurality of smooth and structured metal foils. These are placed alternately on top of one another, so that passages are formed due to the structure of the structured metal foil. These smooth and structured metal foils are then fixed to at least one winding mandrel of the apparatus or the receiving part or receptacle which it forms and then wound. During the winding, the winding mandrel at least from time to time executes a rotary movement, with at least part of the metal foils being in contact on one side with the winding mandrel and on the other side with the at least one shaping segment, and in particular with the guide element or its roll body. In particular, toward the end of the winding process, the clamping jaws are pivoted in the direction of the central region, so that the ends of the metal foils are likewise bent in the direction of the central region. This results in the formation of a honeycomb structure which substantially corresponds to the desired shape of the honeycomb body that is to be produced. In accordance with step b) as elucidated above, the honeycomb structure is at least partially introduced into a housing (step c). In this case, the honeycomb structure can at least temporarily remain in the apparatus or else can be transferred to a further piece of equipment. Finally, the metal foils are at least partially joined to the housing and/or to one another, in step d). The joining includes in particular the welding and/or brazing of the metal foils to one another and/or to the housing. The provision of joining materials, such as for example brazing material or hard solder, may take place before step b) or alternatively after step b) or step c). It is preferable for only a relatively small proportion of the possible joining locations or all of the contact regions of the metal foils with one another and/or between the metal foils and the housing to actually be connected by technical joining. In particular, in the case of large honeycomb bodies, this proportion is, for example, well below 30%. In this way, the thermal properties of a honeycomb body of this type in the exhaust system are taken into account.

In accordance with another mode of the process of the invention, it is advantageous if step a) includes placing smooth metal foils and corrugated metal foils on top of one another alternately to form a stack. In this context it is also preferable if in step b) a plurality of stacks are wound simultaneously, with each stack being assigned a wrap-around mandrel and a shaping segment which are in contact with the stack during winding. In this case it is preferable to produce a honeycomb body using an apparatus that has three wrap-around mandrels and three shaping segments. Further details in this regard are given in connection with the description of the figures.

With the objects of the invention in view, there is furthermore provided a honeycomb structure produced by the apparatus according to the invention. The honeycomb structure comprises a first end side, a second end side, a multiplicity of passages extending from the first end side to the second end side, and

an extent greater than 150 mm.

The term “extent”, for a cylindrical configuration of the honeycomb structure, is to be understood as meaning the diameter, while for other forms it is to be understood as meaning a corresponding, largest possible dimension. This is adapted in particular to large honeycomb structures, wherein the reduced friction during the winding process in particular leads to a noticeably more homogeneous construction of the honeycomb structure.

With the objects of the invention in view, there is additionally provided a honeycomb body produced by the process according to the invention. The honeycomb body comprises a honeycomb structure having a first end side, a second end side, a multiplicity of passages extending from the first end side to the second end side, and an extent greater than 150 mm.

With the objects of the invention in view, there is concomitantly provided a vehicle, comprising a honeycomb structure produced by the apparatus according to the invention, a honeycomb body produced by the process according to the invention, a honeycomb structure according to the invention or a honeycomb body according to the invention.

In connection with the preferred application area, it should be noted that combining a honeycomb structure (produced by using an apparatus according to the invention) and/or a honeycomb body (produced by a process as described above) with a vehicle, in particular a commercial vehicle, has advantages with regard to the conversion of pollutants and service life of the honeycomb structure or honeycomb body.

The invention and the general technical field are explained further with reference to the figures. It should be noted that the figures merely show particularly preferred variant embodiments of the invention without, however, restricting the latter. Furthermore, the figures are generally diagrammatic in form, and consequently they are not usually appropriate for illustrating size ratios.

Other features which are considered as characteristic for the invention are set forth in the appended claims, noting that the features listed individually in the claims can also be combined with one another in any desired and technologically appropriate way, resulting in further configurations of the invention.

Although the invention is illustrated and described herein as embodied in an apparatus and a process for producing metallic honeycomb bodies with at least one shaping segment, a honeycomb structure produced by the apparatus or the process and a vehicle having the honeycomb structure, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, plan view of a variant embodiment of a shaping segment;

FIG. 2 is a cross-sectional view of the shaping segment, which is taken along a line II-II of FIG. 1, in the direction of the arrows, in a region of a guide element;

FIG. 3 is a plan view of three shaping segments in a first phase of a winding process;

FIG. 4 is a view similar to FIG. 3 showing a second phase of the winding process;

FIG. 5 is a view similar to FIG. 3 showing a third phase of the winding process;

FIG. 6 is a view similar to FIG. 3 showing a fourth phase of the winding process;

FIG. 7 is a view similar to FIG. 3 showing a fifth phase of the winding process;

FIG. 8 is a perspective view of a vehicle with an exhaust system having a honeycomb body; and

FIG. 9 is a partly broken-away and perspective view of a honeycomb body.

### DETAILED DESCRIPTION OF THE INVENTION

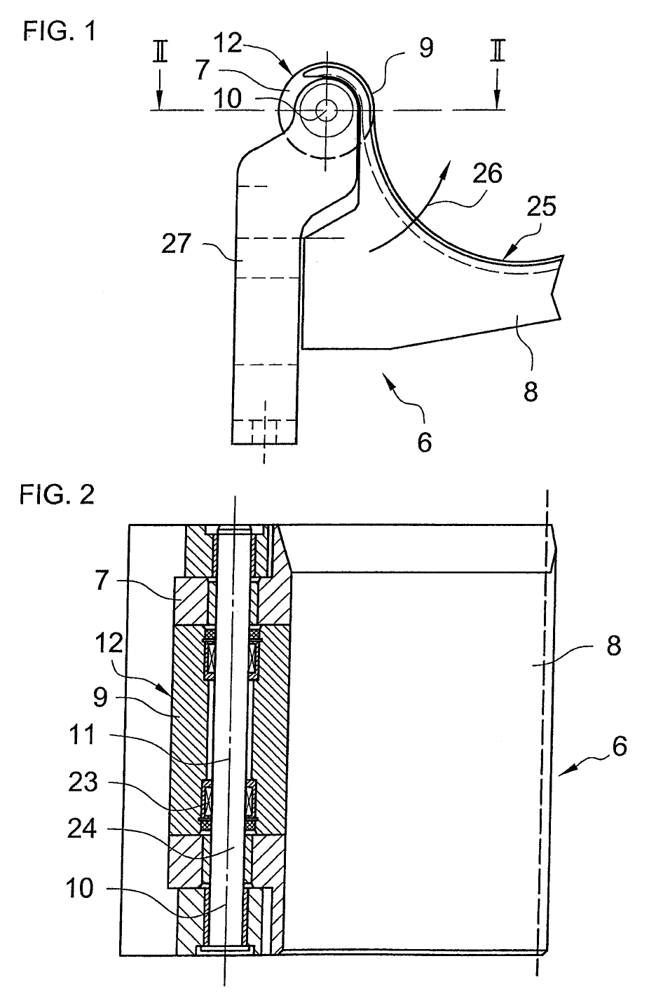

Referring now to the figures of the drawings in detail and first, particularly, to FIG. 1 thereof, there is seen a diagrammatic plan view of a variant embodiment of a shaping segment 6. The shaping segment 6 includes a carrier arm 27, to which a clamping jaw 8 is fixed that can be pivoted in a pivoting direction 26 relative to the carrier arm 27. The clamping jaw 8 has a contour surface 25, which in particular comes into contact with metal foils in a deflected-out final position (only a pivoted-in position is illustrated herein). A guiding element 7 for guiding the at least one non-illustrated metal foil with a roll body 9 is formed adjacent the contour surface 25 of the clamping jaw 8 on the left-hand side. In this case, the roll body 9 is aligned with a pivot axis 10 of the clamping jaw 8.

FIG. 2 illustrates a section through the shaping segment 6 indicated in FIG. 1. In particular, it is possible to recognize herein the structure in the region of the guide element 7. The guide element 7 is constructed with the cylindrical roll body 9 which is mounted rotatably by way of a bolt 24. For this purpose, two bearings 23 are provided between the roll body 9 and the bolt 24. An axis of rotation 11 of the roll body 9 coincides in this case with the pivot axis 10. In the variant embodiment presented herein, the outer surface of the roll body ends flush with that of the guide element 7, so as to form a common contact surface 12 for the metal foils.

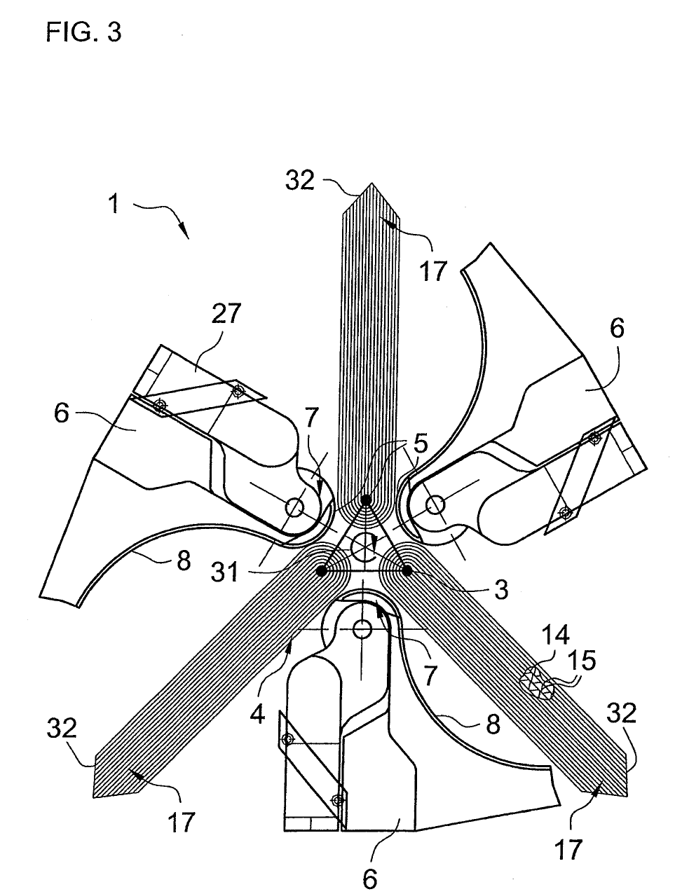

FIGS. 3 to 7 illustrate various phases of a preferred variant embodiment of the winding process, in which three stacks 17 made up of smooth metal foils 14 and structured metal foils 15 are wound together.

It can be seen from FIG. 3 that the stacks 17 have first of all been folded over in the center, so that ends 32 of the metal foils are disposed on only one side of the stack 17. Each stack 17 has been assigned a separate wrap-around or winding mandrel 3 at the side opposite from the ends 32 of the metal foils 14, 15.

The respective wrap-around mandrel 3 is only in contact with the innermost metal foil 14, which largely surrounds it. The three illustrated shaping segments 6 are then moved from the outside into a central region 4 of an apparatus 1, so that the guide elements 7 at least partially come to bear against the outer metal foils of the stack 17. In this way, a receiving part, receptacle or take-up 5 for each stack 17 is then formed by the adjacent guide elements 7 and the respectively associated wrap-around mandrel 3. This constitutes a type of starting position for the winding process that then ensues. The three wrap-around mandrels 3 thereby then begin to rotate in an illustrated direction of rotation 31, with the distance between the wrap-around mandrels 3 remaining constant.

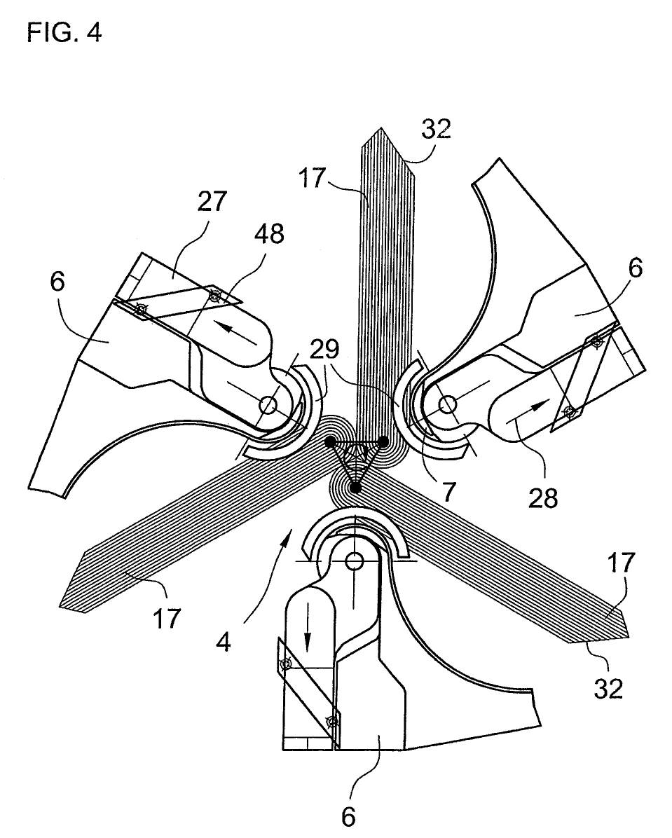

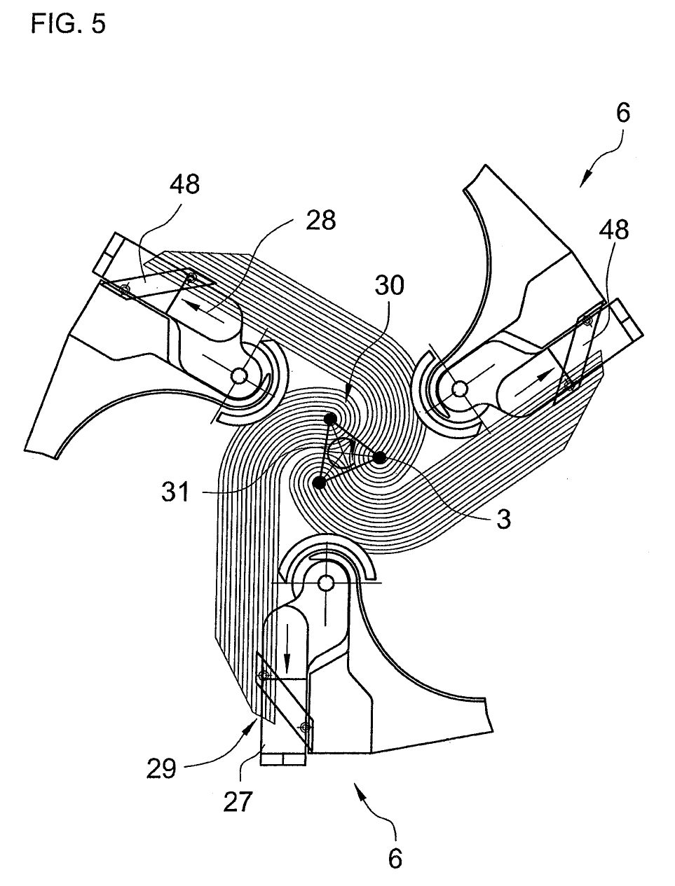

A subsequent phase of the winding process results, for example, in the configuration illustrated in FIG. 4. During the rotary movement of the wrap-around mandrels 3 that has already taken place, the guide elements 7 in each case form a guide region 29 for the stacks 17. This guide region 29 is substantially formed by the roll body (not labeled by a lead line in FIG. 4) of the guide element 7. A holder 48 is connected, for example, to a non-illustrated baseplate of the apparatus 1. With regard to the sequence of movement of the shaping segments 6, it should be noted that they move away from the central region 4 in a translational direction 28. This can be seen, for example, from the relative position of the carrier arm 27 and the holder 48 in all phases.

As a result of the progressive rotational process of the wrap-around mandrels 3, finally a guide region 29 is also formed in the region of the support arm 27, so that the stacks 17 are guided into the central region of the apparatus 1 by a plurality of shaping segments 6 in each case, as is illustrated in FIG. 5. It can be seen that the stacks 17 increasingly come to bear against one another and partially surround one another in the center of the apparatus 1. As a result of a honeycomb structure 2 which is building up in the central region 4 of the apparatus 1, the individual shaping segments 6 are moved further outward in the translational direction 28.

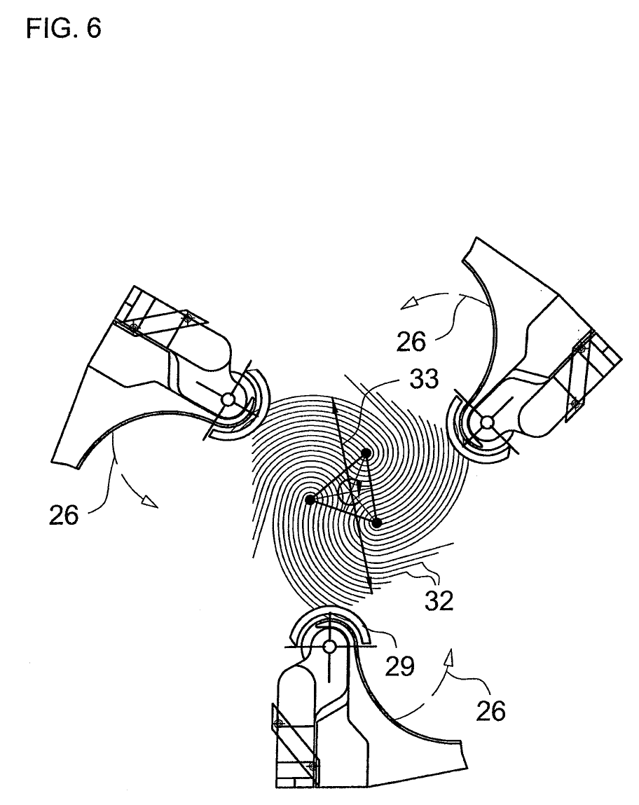

FIG. 6 illustrates a transition phase from the pure winding process to a deformation process. In this case, the guide regions 29 which have been formed by the respective guide elements 7 and roll bodies 9 are now already in the region of the ends 32 of the metal foils 14, 15. At this point in time, the honeycomb structure 2 can no longer be built up any further, since all that is formed is three punctiform abutments between the large number of metal foils 14, 15 and the shaping segments 6. The result is a diameter 33 at which the honeycomb structure 2 can no longer be continued to be built up from the “inside outward”, but rather is subsequently built up from the “outside inward”. For this purpose, the clamping jaws 8 are now pivoted toward the central region 4, as is illustrated by a pivoting direction 26 shown in dashed lines.

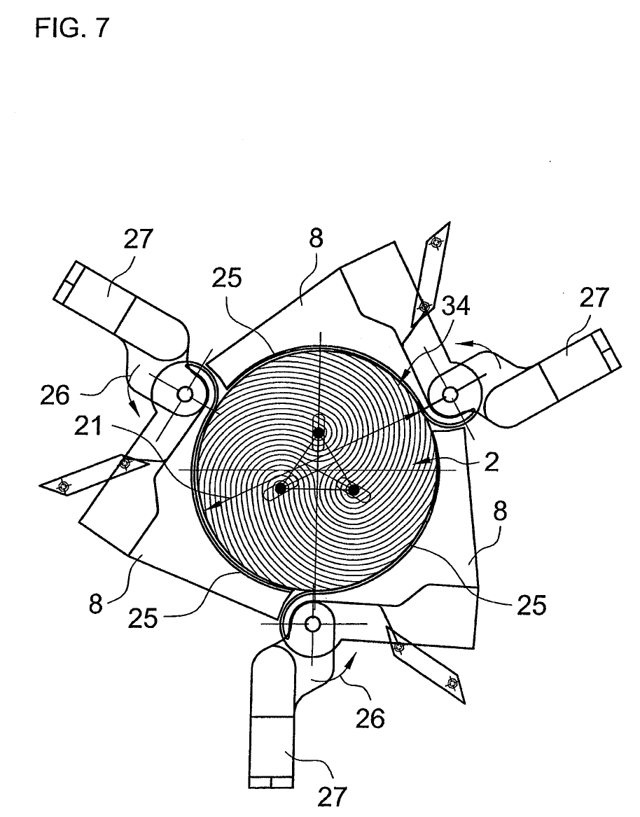

FIG. 7 illustrates a final phase of the winding process. At this point in time, the clamping jaws 8 have been moved fully out in the pivoting direction 26. The contour surfaces 25 in this case form a circumference 34 of the honeycomb structure 2 having a desired extent 21. In other words, all of the ends 32 of the metal foils 14, 15 now bear against a contour surface 25 of a shaping segment 6. In the variant shown herein, the contour surfaces 25 of the shaping segment 6 produce a circle or cylinder shape, although this is not necessarily the case. It is equally possible to produce other contours.

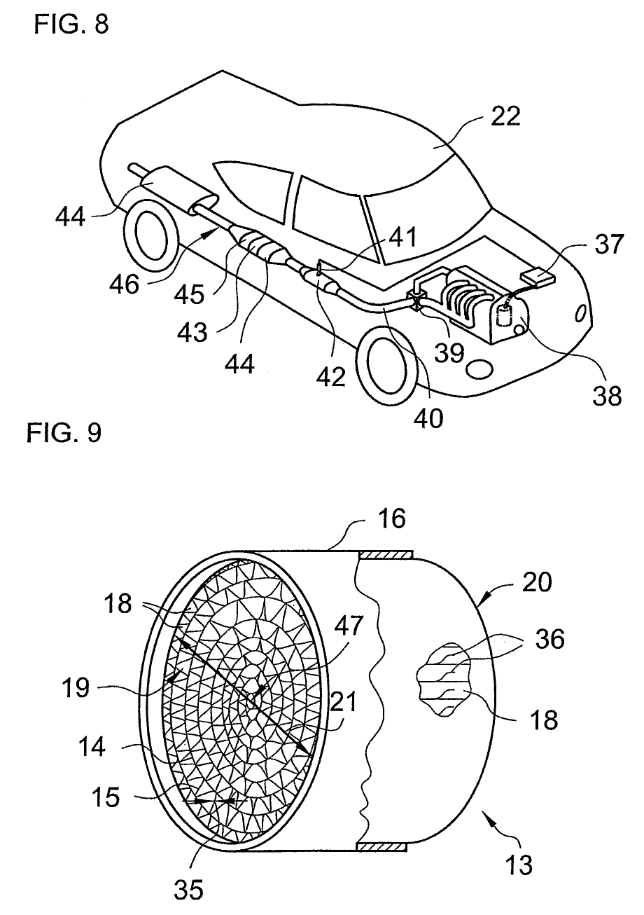

FIG. 8 is intended to illustrate the preferred use of a honeycomb body produced by using the apparatus or the process described above. This use is, in particular, in the automotive sector. The figure illustrates a vehicle 22 which has an internal combustion engine 38 (e.g. a spark-ignition or diesel engine). The internal combustion engine 38 is operated under the control of an engine control unit 37, and a measuring device 41 for determining constituents or conditions in an exhaust system 46 is provided in the exhaust system 46. The engine control unit 37 can influence or control the operating mode of the internal combustion engine 38 on the basis of the recorded measured values. In this case, the exhaust gas flows through the exhaust system 46 in a preferred direction of flow and as it does so, it passes in succession through the following components, which are at least in some cases connected to one another through an exhaust pipe 40: a turbocharger 39, a flow mixer 42, a catalytic converter 44 (which is constructed as an oxidation catalytic converter), a particulate trap 43, an adsorber 45 and a final, further catalytic converter 44, for example a three-way catalytic converter.

FIG. 9 diagrammatically depicts a perspective illustration of a variant embodiment of a honeycomb body 13 built up in a spiral form around a winding point 47. This honeycomb body 13 has a smooth metal foil 14 and a corrugated, structured metal foil 15, which are disposed in a spiral so as to form a large number of passages 18 extending from a first end side 19 to a second end side 20, with the extent 21 being greater than 150 mm. Microstructures 36 for influencing the flow are provided in the interior of the passages 18. It is preferable for the two metal foils 14, 15 to have the same foil thickness 35 which, for example, is in a range of from 0.15 mm to 0.03 mm. The honeycomb body 13 is introduced into a housing 16 and the metal foils 14, 15 are joined to the housing 16.

1. An apparatus for winding at least partially structured metal foils to form a honeycomb structure, the apparatus comprising:
a central region of the apparatus;
at least one wrap-around mandrel disposed in said central region and having a receiving part for at least one metal foil; and
at least one shaping segment having at least one guide element for guiding the at least one metal foil during winding and at least one pivotable clamping jaw, said at least one guide element having at least one roll body.

2. The apparatus according to claim 1, wherein said at least one shaping segment is movable relative to said at least one wrap-around mandrel.

3. The apparatus according to claim 1, wherein said at least one guide element of said at least one shaping segment is one guide element, said at least one clamping jaw of said at least one shaping segment is one clamping jaw, and said guide element and said clamping jaw are disposed adjacent one another.

4. The apparatus according to claim 1, wherein said at least one clamping jaw has a pivot axis, said at least one roll body has an axis of rotation, and said pivot axis and said axis of rotation coincide.

5. The apparatus according to claim 1, wherein said at least one guide element forms a contact surface for the at least one metal foil, and at least 50% of said contact surface is formed by said at least one roll body.

6. The apparatus according to claim 1, wherein said at least one roll body of said at least one guide element protrudes toward said central region of the apparatus.

7. A process for producing a honeycomb body with at least partially structured metal foils, the process comprising the following steps:
a) providing at least one smooth metal foil and at least one structured metal foil;
b) winding the metal foils to form a honeycomb structure using an apparatus according to claim 1;
c) introducing the honeycomb structure into a housing; and
d) joining the metal foils to the housing.

8. The process according to claim 7, which further comprises carrying out step a) by placing smooth metal foils and corrugated metal foils alternately on top of one another to form a stack.

9. The process according to claim 8, which further comprises carrying out step b) by simultaneously winding a plurality of stacks, each stack being assigned a wrap-around mandrel and a shaping segment being in contact with said stack during winding.

10. A honeycomb structure, comprising:
at least partially structured metal foils wound by the apparatus according to claim 1;
a first end side;
a second end side;
a multiplicity of passages extending from said first end side to said second end side; and
an extent greater than 150 mm.

11. A honeycomb body, comprising:
a honeycomb structure produced by the process according to claim 7;
said honeycomb structure having a first end side, a second end side, a multiplicity of passages extending from said first end side to said second end side, and an extent greater than 150 mm.

12. A vehicle, comprising a honeycomb structure produced by the apparatus according to claim 1.

13. A vehicle, comprising a honeycomb body produced by the process according to claim 7.

14. A vehicle, comprising:
a honeycomb structure including at least partially structured metal foils wound by the apparatus according to claim 1, said honeycomb structure having a first end side, a second end side, a multiplicity of passages extending from said first end side to said second end side, and an extent greater than 150 mm.

15. A vehicle, comprising:
a honeycomb body including a honeycomb structure produced by the process according to claim 7, said honeycomb structure having a first end side, a second end side, a multiplicity of passages extending from said first end side to said second end side, and an extent greater than 150 mm.
